(19) United States
(12) Patent Application Publication
(10) Pub. No.: US 2015/0343717 A1
(43) Pub. Date: Dec. 3, 2015

(54) METHOD AND INSTALLATION FOR PRODUCING A FIBER-REINFORCED PLASTIC COMPONENT

(71) Applicant: Dieffenbacher GmbH Maschinen- und Anlagenbau, Eppingen (DE)

(72) Inventors: Matthias GRAF, Eppingen (DE); Tobias FÜRST, Eppingen (DE)

(73) Assignee: Dieffenbacher GmbH Maschinen- und Anlagenbau, Eppingen (DE)

(21) Appl. No.: 14/438,528

(22) PCT Filed: Oct. 25, 2013
(86) PCT No.: PCT/EP2013/072371

§ 371 Date: Jun. 25, 2015

(30) Foreign Application Priority Data
Oct. 29, 2012 (DE) 10 2012 110 353.4

(51) Int. Cl. B29C 70/54; B29C 70/48

(52) U.S. Cl. CPC B29C 70/54; B29C 70/48; B29C 70/545; B29K 2105/0872

(57) ABSTRACT

A method for producing a fiber-reinforced plastic component including: cutting individual fiber mats to size; stacking multiple fiber mats to form a fiber semifinished product outside or inside a molding tool, which comprises at least two tool parts; performing a preform process to produce a fiber preform of the plastic component; and performing an RTM process to produce a main form of the plastic component. The method is distinguished by application and/or introduction, which is before, simultaneous, and/or after, of an at least partially circumferential sealant material, which is suitable for use as a sealant, to individual, multiple, and/or all fiber mats and/or the fiber semifinished product; wherein the application and/or the introduction of sealant material is performed such that at latest before the performance of the RTM process in a particularly completely circumferential edge region of the fiber preform, all fiber pores and intermediate spaces therein are closed by the sealant material.

The present invention relates to a method for producing a fiber-reinforced plastic component comprising at least the method steps according to the preamble of Patent claim 1. The subject matter of the present invention is also a facility for carrying out the method according to the preamble of Patent claim 11.

The resin transfer molding method (RTM method) is known, inter alia, for the production of fiber-reinforced plastic components (fiber composite components) and in particular carbon fiber-reinforced plastic components (CFRP components). The production of a fiber composite component by means of this method is performed in industrial use in sequentially running individual processes.

In a first process step, the so-called preform process, the fiber semifinished products, which are generally provided as a multilayered fabric or scrim of fiber mats which are cut to size, are shaped, so that they already approximately have the geometry of the composite component to be manufactured. The individual fiber mats of the fiber semifinished products generally also have, in addition to the fiber mats themselves, a binder, which has adhesive-type properties. The binder causes pre-solidification of the individual fiber mats with one another and therefore of the pre-formed fiber preform (of the blank), so that they can be supplied in a dimensionally-stable manner to the following processes. The fiber preform can also only be called a preform.

For the preform process, pre-assembled fiber mats are thus generally laid one on top of another in layers to form a fiber semifinished product according to a predefined fiber layer structure. This fiber semifinished product, which is formed from fiber mats, is subsequently transferred into a preform tool at room temperature, or heated to a shaping temperature. The shaping of the fiber semifinished product into a fiber preform is performed by closing the tool. Finally, the edge region of the fiber preform thus created can also be trimmed (also referred to as trimming or net shaping hereafter), for example, by stamping or ultrasonic cutting, so that the fiber preform has defined contour edges. The fiber preform is subsequently demolded and optionally temporarily stored for carrying out the following process and method steps.

A first quality control can already take place during the temporary storage. By means of a visual check, in particular the molding burr of the fiber preform (of the blank) and possible fiber warping, fiber waviness, wrinkles, or similar superficial flaws can be recognized in this case.

In a following second process step, the RTM process, the fiber preform is laid in a cleaned and preferably release-coated, i.e., coated with an anti-adhesive agent, cavity of an RTM tool. The molding tool, which is typically in two parts, is subsequently closed by means of a press and a two-component resin system is injected into the cavity of the molding tool, wherein it penetrates the fiber structure of the fiber preform as a matrix material and encloses the fibers. After the curing of the resin system, the main form of the fiber-reinforced plastic component thus obtained can be demolded and optionally checked for quality again. To keep the tool closed leak-tight during the injection of the resin, for the infiltration of the fiber preform, an elastomeric seal is typically located between the tool upper part and the tool lower part. Generally, commercially available round cord seals are used for this purpose. The fiber preform must also be very precise in its external contour in this case. This is usually achieved, as already described, by trimming the preform before the RTM process. In this case, however, it is still unavoidable that a gap exists between the preform and the seal. This gap has the negative property that a type of “channel” arises, usually in the edge region, through which the resin flows in in an uncontrolled manner and short-circuits the flow front inside the fiber preform. In this way, undesired air enclosures and incorrect impregnation can occur. In addition, the “channel” must also be filled with resin, which results in increased resin consumption and therefore in particular in competitive disadvantages in mass production.

To implement a fully automatic mass production process in the RTM method, the fact that the seal arranged between tool upper part and tool lower part comes into contact with resin and must either be cleaned in a time-consuming manner or even must be cyclically replaced after the cycle is one of the significant handling requirements.

To improve this, DE 10 2007 046 734 A1 proposes that, in the open RTM molding tool, a non-gas-tight seal is applied to the edge region of the fiber semifinished product laid in the tool. This seal can be embodied as a rapidly curing, flexible plastic or as a gas-permeable consumable sealing cord. If the RTM molding tool is closed, in this case the adhesive or the consumable sealing cord is compressed and partially pressed into the fiber semifinished product, but only enough that a pressure equalization between the edge region and the central region of the cavity of the molding tool is still possible, in that the air can penetrate the fiber intermediate spaces of the lower layers of the fiber semifinished product when the air present in the cavity of the molding tool has been substantially evacuated.

The approach of the squeezed edge seal has also been introduced in the search for suitable sealing methods. In this case, the fiber preform is over-compacted on its peripheral outer edge via a squeezed edge in the molding tools of the RTM molding tool. As in the case of the non-gas-tight seal, which is only partially pressed into the fiber material, known from DE 10 2007 046 734 A1, the resin experiences a higher flow resistance at this squeezing point and does not flow outside the squeezing edge at low injection pressures of 5 or 10 bar.

The known types of seals do not function reliably in a process, however, and experience has shown that they are additionally only usable at injection pressures of up to 10 bar or at most 20 bar. At pressures lying above this, the leak-tightness cannot be reliably maintained by means of a squeezing edge or by means of the non-gas-tight seal known from DE 10 2007 046 734 A1. A fabric stack, which is formed from stacked fiber mats, not only over-compacts a squeezing edge, but rather also simultaneously forms a wedge therein, which is no longer leak-tight at higher pressures. The fiber intermediate layers of the lower layers of the fiber semifinished product left for the air passage also form a channel for a resin which is injected under high pressure or over-compacted in the case of the non-gas-tight seal known from DE 10 2007 046 734 A1.

High cavity pressures of for example, 35 to 100 bar or more are intrinsic to current so-called high-pressure RTM methods (HP-RTM), however, which concentrate on the production of fiber-reinforced plastic components in particular, such as high-performance fiber composite materials, by means of the most rapid possible resin injection with complete impregnation of the textile fiber reinforcement structures by the use of highly reactive resin systems. A drastic reduction of the heretofore typical cycle times results therefrom. A high-pressure RTM facility is used for the homogeneous mixing of highly reactive resin components and curing agent components. A differentiation is made in this case between high high-pressure compression RTM methods (HP-CRTM) and high-pressure injection RTM methods (HP-IRTM).

In the HP-CRTM process, the resin is injected into a molding tool, which is (slightly) opened in a defined manner and contains a fiber preform. After the injection operation, the molding tool is closed and the fiber preform is both compacted (over-compacted) and also simultaneously impregnated because of the high tool internal pressure of up to 100 bar, which results from the closing forces of the hydraulic press.

In the HP-IRTM method, the fiber preform, which is already located in a completely closed molding tool, is impregnated by a significant high resin injection pressure of, for example, 35 bar. The high injection pressure results in a time shortening of the impregnation phase.

Both HP-RTM methods have the advantages of:
short injection and impregnation times in the HP-CRTM and HP-IRTM methods;
short cycle times due to the use of highly reactive resin systems;
economically and ecologically efficient processing process, since comparatively very low resin excesses are used;
providing an optimized resin-fiber ratio in the plastic molded part, in particular for light construction.

The present invention is based on the object of providing a sealing method improved in relation to the prior art, which in particular reliably avoids contamination of the seal arranged between the tool parts with resin and at the same time, using the advantages of the RTM method and in particular the high-pressure RTM method (HP-RTM), is both cost-effective and suitable for automated mass production processes.

This object is achieved by a method for producing a fiber-reinforced plastic component having the features of Patent claim 1 and by a facility for carrying out the method having the features of Patent claim 11. Advantageous embodiments and refinements, which can be used individually or in combination with one another, are the subject matter of the dependent claims.

The method according to the invention for producing a fiber-reinforced plastic component is distinguished in relation to the known methods by application and/or introduction, which is before, simultaneous, and/or after in relation to method steps 1.2 and/or 1.3, of an at least partially circumferential material, which is suitable for use as a sealant, to individual, multiple, and/or all fiber mats and/or the fiber semifinished product, wherein the application and/or the introduction of sealant material is performed such that at latest before the RTM process provided according to step 1.4 is carried out, in a preferably completely circumferential edge region of the fiber preform, all fiber pores and intermediate spaces therein are closed by the sealant material.

The implementation of a fiber preform having a preferably completely circumferential edge region closed by the sealing material has the advantage that even at high injection pressures of, for example, 35 bar and/or high tool pressures of, for example, 100 bar or greater, as these pressures are intrinsic to HP-RTM processes in particular, no resin can pass the fiber pores and fiber intermediate spaces, which are closed using sealant material, of the completely circumferential edge region of the fiber preform.

Therefore, it can advantageously be ensured for the first time, even for HP-RTM methods, that no resin reaches the seals arranged in the RTM tool between tool upper part and tool lower part, so that they are no longer soiled because of resin and have to be cleaned in a time-consuming manner or cyclically replaced for this reason.

In a first embodiment of the invention, the sealant material can be at least partially circumferentially applied and/or introduced on individual, multiple, and/or all fiber mats during or after the cutting to size (assembly) of the fiber mats provided according to method step 1.1.

According to an alternative or cumulative embodiment of the invention, the sealant material can be at least partially circumferentially applied and/or introduced on individual, multiple, and/or all fiber mats before or during the stacking of the fiber mats to form a fiber semifinished product provided according to method step 1.2.

Again alternatively or additionally, in a further embodiment of the present invention, the sealant material can be at least partially circumferentially applied and/or introduced on the fiber semifinished product before the performance of a preform process provided according to method step 1.3.

In a further alternative or additional embodiment of the present invention, the sealant material can be at least partially circumferentially applied and/or introduced on the fiber preform after the performance of a preform process provided according to method step 1.3.

Finally, in a further alternative or additional embodiment of the present invention, trimming of the edge region of the fiber mats, the fiber semifinished product, and/or the fiber preform can be carried out before or after the application and/or the introduction of the sealant material.

In particular a sealing cord and/or an adhesive and/or an elastomeric material, for example, silicone or polyurethane have proven themselves as a sealant material, and/or such materials having low viscosity properties in the uncured state for penetration into the fiber pores and intermediate spaces of the fiber mat, the fiber semifinished product, and/or the fiber preform.

The fixation of the individual fiber mats can classically be performed by means of binding agents. Alternatively or additionally, it can be preferable to achieve fixation of the fiber mats solely by a sealant material applied and/or introduced on each fiber mats and/or at least adjacent fiber mats, which holds together the fiber mats layered to form the fiber semifinished product so that the classical binding step of the fiber mats can be omitted.

Sealant materials having rapidly curing properties after application, whether natural or artificially promoted, have not only proven themselves in this regard, which advantageously makes the further processing easier in subsequent method and/or process steps, in particular before or during the preform process provided according to method step 1.3 and/or the RTM process provided according to method step 1.4.

Finally, a final form of the plastic component can be obtained by trimming the main form of the plastic component while cutting off the sealant material.

The subject matter of the present invention is also a facility for carrying out a method for producing a fiber-reinforced plastic component, in particular a method as described above. The facility according to the invention is distinguished by application and/or introduction means for the purpose of application and/or introduction of an at least partially circumferential material, which is suitable for use as a sealant, to individual, multiple, and/or all fiber mats and/or the semifinished product, before, simultaneously, and/or after with respect to method steps 1.2 and/or 1.3, in such a manner that at latest before the performance of the RTM process provided according to method step 1.4, in a completely circumferential edge region of the fiber preform, all fiber pores and fiber intermediate spaces therein are closed by the sealant material.

In a first embodiment of the facility, for example, an application and/or introduction means implemented as a flathead nozzle has proven itself, which is guided at a defined distance to a fiber mat or a fiber semifinished product so that the material suitable for use as a sealant is applied and/or introduced by means of the flathead nozzle, in that it preferably pumps the sealant material with pressure into the fiber pores and fiber intermediate spaces of one or more fiber mats.

Insofar as the sealant is initially only applied to a fiber mat and/or is only partially introduced into the fiber pores and fiber intermediate spaces of the fiber mat, implementing a squeezing edge has proven itself, by means of which the sealant material can be introduced or can be over-compacted after introduction has already occurred into all fiber pores and intermediate spaces of each fiber mat upon the closing of the molding tool, in at least one preform tool part of the preform tool for producing the fiber preform and/or in at least one tool part of the molding tool for producing the main form at the height, which comes to rest in the tool parts, of the sealant material applied to the fiber mats.

To reduce the cycle times and/or to increase the process reliability, for example, by reliable edge compression, the natural curing of the sealing material can be artificially assisted by means of heat action. Means for promoting curing of the sealant material by means of heat action, for example, hot presses, can preferably be provided for this purpose in the preform tool.

The production of the fiber preform of the plastic component and the production of the main form of the plastic component can be performed in the same molding tool. The disadvantage linked thereto of longer process cycles is balanced out by the early recognition of process flaws as an advantage.

Insofar as the individual process or method steps are preferably entirely or partially subjected to a separate quality check, executing the production of the fiber preform of the plastic component in a preform tool and the production of the main form of the plastic component in the cavity of an at least two-part main tool or molding tool has also proven itself.

The present invention ensures for the first time reliable closing of all fiber pores and intermediate spaces in a circumferential edge region of a fiber mat, a fiber semifinished product, and/or a fiber preform. It is therefore suitable in particular for so-called high-pressure RTM methods (HP-RTM).

These and further features and advantages of the invention will be explained in greater detail hereafter on the basis of the exemplary embodiments illustrated in the drawings—to which the present invention is not restricted, however.

In the schematic figures:

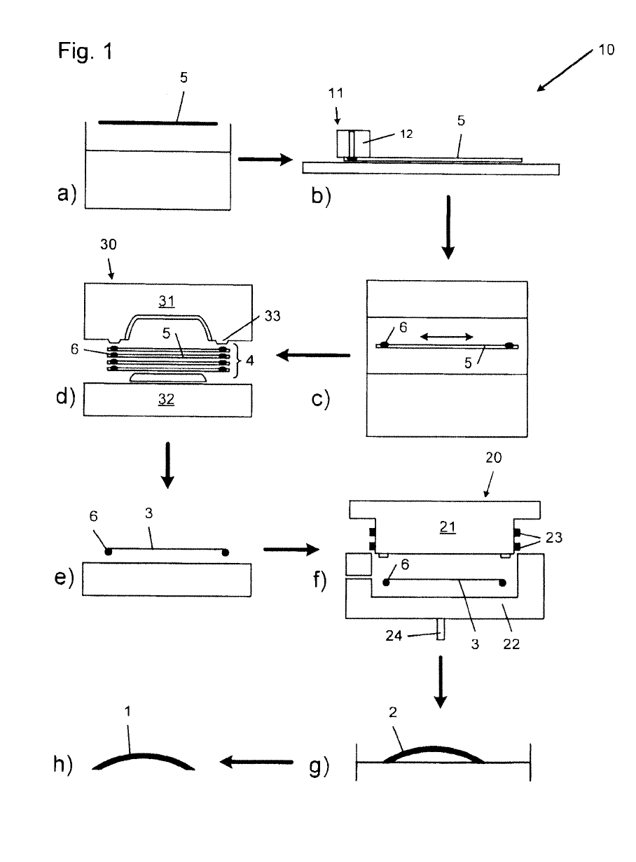

FIG. 1 shows the typical stations a) to h) of a facility for performing a method for producing a fiber-reinforced plastic component;

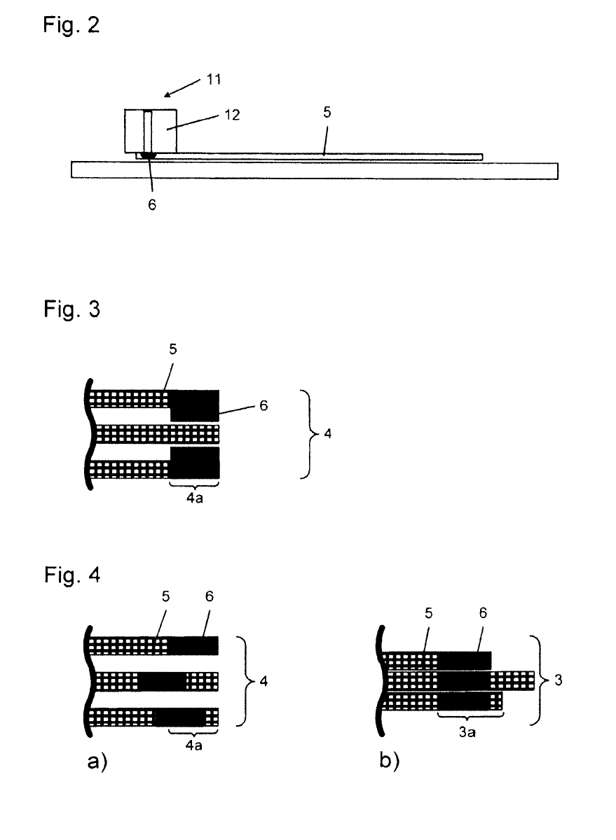

FIG. 2 shows an application and/or introduction means implemented as a flathead nozzle;

FIG. 3 shows the application or the introduction of sealant material to at least every other fiber mat of a fiber semifinished product with excess;

FIG. 4 shows the application or the introduction of sealant material into each fiber mat of a fiber semifinished product with a further illustration of the displacement of the fiber mats in relation to one another in the course of shaping to form a fiber preform;

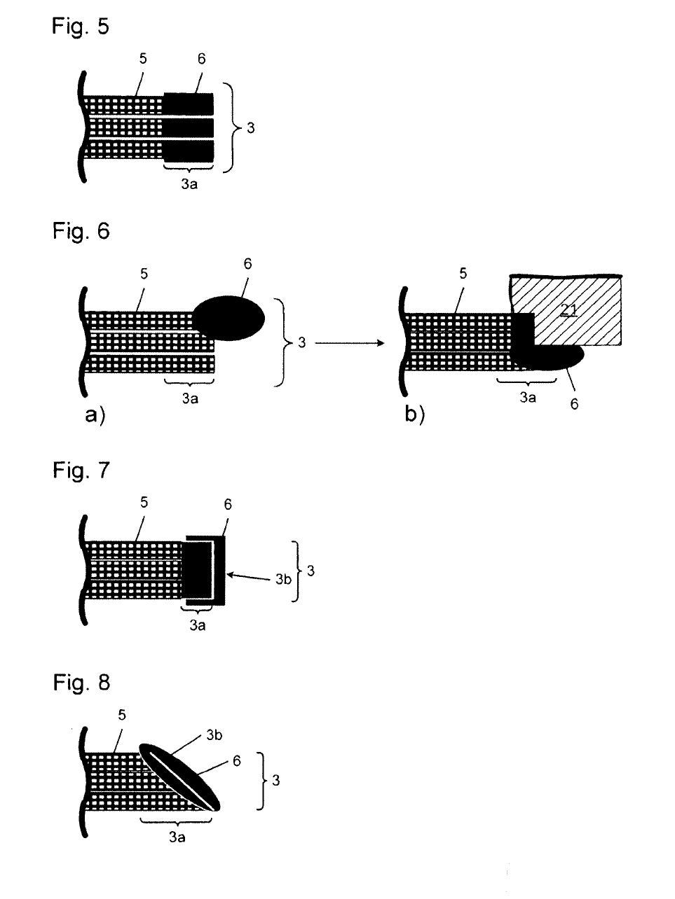

FIG. 5 shows the application or the introduction of sealant material into at least two layers of the fiber mats of a fiber preform obtained by forming a fiber semifinished product;

FIG. 6 shows the adhesion of sealant material on the edge section of a fiber preform, with an illustration of the sealing behavior during the RTM process;

FIG. 7 shows a first application of the application or introduction of sealant material to the cut edge of an already trimmed fiber preform;

FIG. 8 shows a second application of the application or the introduction of sealant material to the cut edge of an already trimmed fiber preform; and

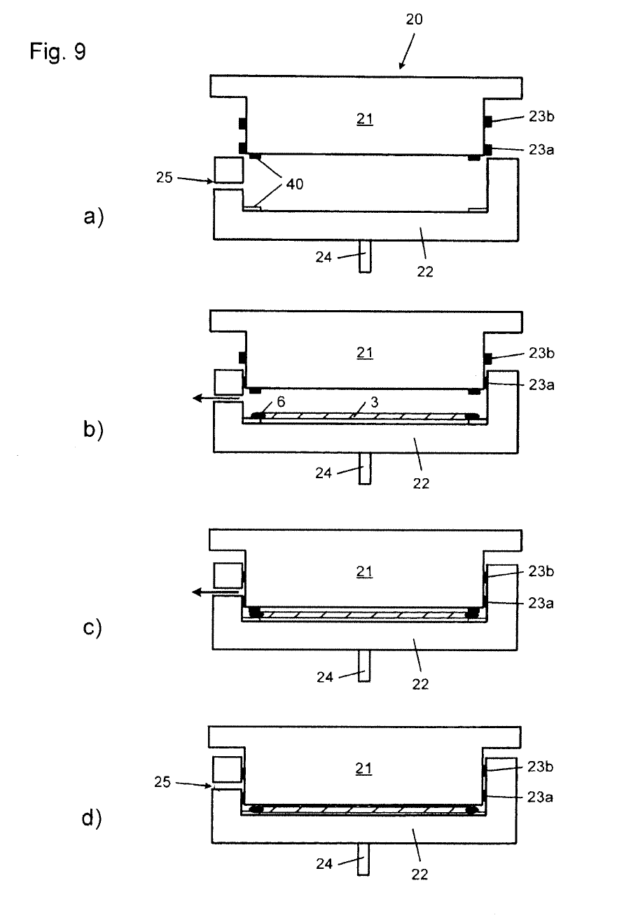

FIG. 9 shows typical process steps a) to d) in an RTM facility, in particular for the performance of an HP-CRTM method, for producing a fiber-reinforced plastic component.

In the following description of preferred exemplary embodiments, identical reference signs identify identical components. For the introductory explanation, various reference signs and components are explained beforehand for better comprehension, as they are understood by the invention.

A fiber preform 3 is produced in the course of production from a fiber semifinished product 4, which in turn consists of at least two fiber mats 5 or of comparable fiber woven materials and can therefore also be referred to as a fiber mat stack. The fiber preform 3 has in this case an edge region 3a, which also is or can be cut to size and therefore forms an outer contour or outer edge, respectively, as the cut edge 3b of the fiber preform 3. The fiber semifinished product 4 also has an edge region 4a. The main form 2 of the finished plastic component 1 essentially only differs in transfer or processing steps which are still required, and which do not have to be explained in greater detail here.

FIG. 1 schematically shows typical stations a) to h) of a facility 10 for performing a method for producing a fiber-reinforced plastic component 1, at least comprising the following method steps: cutting to size individual fiber mats 5 (method step 1.1) in a cutting station (cf. FIG. 1a); stacking—with or without binding agent—(cf. FIG. 1c) multiple fiber mats 5 to form a fiber semifinished product 4 outside or inside a preform tool 30 comprising at least two tool parts 31, 32 (method step 1.2) of a preform facility (cf. FIG. 1d) or—in particular if preform and main molding tools are implemented integrally (not shown)—within a molding tool 20, comprising at least two tool parts 21, 22, of an RTM facility; performing a preform process to produce a fiber preform 3 (cf. FIG. 1d/e) of the plastic component 1 (method step 1.3) in the preform tool 30 of a preform facility (cf. FIG. 1d) or of the molding tool 20 and carrying out an RTM process to produce a main form 2 of the plastic component 1 (method step 1.4) in the molding tool 20 of an RTM facility (cf. FIG. 1f).

The facility 10 according to the invention is distinguished by application and/or introduction means 11 (cf. FIG. 1b) for the purpose of application and/or introduction, which is before, simultaneously, and/or after in relation to method steps 1.2 and/or 1.3, of an at least partially circumferential sealant material 6, which is suitable for use as a sealant, to individual, multiple, and/or all fiber mats 5 and/or the fiber semifinished product 4 such that, at latest before the performance of the RTM process provided according to method step 1.4, in a preferably completely circumferential edge region 3a of the fiber preform 3, all fiber pores and fiber intermediate spaces therein are closed by the sealant material 6.

FIG. 2 shows an application and/or introduction means 11, implemented, for example, as a flathead nozzle 12. It can be seen that the flathead nozzle 12 can be guided at a defined distance to a fiber mat 5 or—in particular if the application and/or introduction means is implemented in one of the tools 31, 32 or 21, 22 (not shown)—a fiber semifinished product 4 so that the sealant material 6, which is suitable for use as a sealant, is applied and/or introduced by means of the flathead nozzle 12, in that, in particular in the latter case, it presses or pumps the sealant material 6 preferably with pressure into the fiber pores and fiber intermediate spaces of one or more fiber mats 5.

In a first embodiment of the invention, the sealant material 6 can be at least partially circumferentially applied and/or introduced to individual, multiple, and/or all fiber mats 5 during or after the cutting to size (assembly) of the fiber mats 5 provided according to method step 1.1.

According to an alternative or additional embodiment of the invention, the sealant material 6 can be at least partially circumferentially applied and/or introduced on individual, multiple, and/or all fiber mats 5 before or during the stacking of fiber mats 5 to form a fiber semifinished product 4 provided according to method step 1.2.

Alternatively or additionally, in a further embodiment of the present invention, the sealant material 6 in turn can be at least partially circumferentially applied or introduced on the fiber semifinished product 4 before the performance of a preform process provided according to method step 1.3.

In a further alternative or additional embodiment of the present invention, the sealant material 6 can be at least partially circumferentially applied and/or introduced on the fiber preform 3 after the performance of a preform process provided according to method step 1.3.

Finally, in a further alternative or additional embodiment of the present invention, trimming of the edge region 3a of the fiber mats 5, the fiber semifinished product 4, and/or the fiber preform 3 can be performed before or after the application and/or the introduction of the sealant material.

If the edge region 3a of the fiber preform 3 is firstly trimmed, the trimmed edge 3a of the fiber preform 3 can itself be effectively sealed advantageously by means of a sealant material 6—so that previous application and/or introduction of sealant material 6 can be omitted.

If sealant material 6 was previously applied and/or introduced in the edge region 3a of the fiber preform 3, after sufficient curing, this advantageously makes the trimming of the edge region 3a easier and/or it advantageously counteracts fraying of the edge region 3a during the trimming. The sealant material 6 is also used as an edge and/or warping protection in the course of the further handling or transfer of the fiber preform 3.

Depending on the quality of the desired plastic component 1 used and the RTM method, in particular HP-RTM method used, both the application and/or the introduction into individual, multiple, and/or all fiber mats 5 and/or the fiber semifinished product 4 and/or the fiber preform 3 and/or its trimmed edge region 3a can be expedient. The respective applied and/or introduced sealant material 6 is preferably applied circumferentially in each case. However, at least partially circumferential, i.e., sectional applications and/or introductions of sealant materials 6 are also conceivable. These should preferably result together in a completely circumferential edge region 3a of the fiber preform 3. However, this is dependent on a variety of influences, of course, for example, the tool geometry and or the geometry of the plastic molded part 1 to be manufactured.

It is therefore particularly preferable that, at latest before the performance of the RTM process provided according to method step 1.4, in a completely circumferential edge region 3a of the fiber preform 3, all fiber pores and fiber intermediate spaces therein are closed by the sealant material 6, whether or not the sealant material 6 has also already been applied or introduced completely or partially circumferentially.

A partial circumferential application and/or introduction, whether in sections or circumferential edge intervals differing from fiber mat 5 to fiber mat 5, has the advantage of the ability to incorporate sometimes significantly different draping distances of individual mats of the fiber semifinished product 4 during the shaping into the fiber preform 3. It is similarly emphasized once again here that preferably, in the case of partial circumferential application or introduction of the sealant material 6, a sufficient number of sections and/or different edge intervals are to be dimensioned so that as much as possible all fiber pores and fiber intermediate spaces of a complete circumferential edge region 3a of a fiber preform 3 are finally closed, i.e., sealed, using sealant material 6.

In particular a sealing cord and/or an adhesive and/or an elastomeric material, for example, silicone or polyurethane has proven itself as the sealant material 6, and/or those materials having low viscosity properties in the uncured state for penetration into the fiber pores and intermediate spaces of the fiber mat 5, the fiber semifinished product 4, and/or the fiber preform 3.

The fixation of the individual fiber mats 5 can classically be performed using binding agents. Alternatively or additionally, it can be preferable to achieve fixation of the fiber mats 5 solely by way of a sealant material 6 applied and/or introduced to each fiber mat 5 and/or at least adjacent fiber mats 5, which holds together the fiber mats 5 layered to form the fiber semifinished product 4 so that sometimes the classical binding agent step of the fiber mats 5 can be omitted or also fiber mats S previously treated with binding agent are unnecessary.

In particular sealant materials 6 having rapidly curing properties after application, naturally or artificially promoted, have proven themselves not only in this regard, for the purpose of easier further processing in subsequent method or process steps, in particular before or during the preform process provided according to method step 1.3 and/or the RTM process provided according to method step 1.4.

FIGS. 3 and 4 show various applications of the application or the introduction of sealant material 6 to individual fiber mats 5 before, during, or after they are cut to size or during the stacking thereof to form a fiber semifinished product 4.

FIG. 3 shows the application or the introduction of sealant material 6 to at least every other fiber mat 5 of a fiber semifinished product 4 with excess. The excess of sealant material 6 on the sealed mats 5 takes over the sealing of the untreated fiber mats 5 in the compacted state. The compaction can be encouraged or performed, for example, by an edge compression, in particular by means of a squeezing edge 40, which is implemented at the height coming to rest in the tool parts 21, 22; 31, 32 of the sealant material 6 applied to the fiber mats 5, of a means 33 provided in the preform tool 30 for producing the fiber preform 3 for promoting curing of the sealant material 6 by means of heat action, such as hot pressing beads (cf. FIG. 1d) and/or in the molding tool 20 for producing the main form 2 (cf. FIG. 9).

FIG. 4 shows the application or the introduction of sealant material 6 to every fiber mat 5 of a fiber semifinished product 4. As shown in FIG. 4a on a fiber semifinished product 4 before its shaping, the application or the introduction of the sealant material 6 can optionally be performed offset from fiber mat 5 to fiber mat 5, so that after shaping, in spite of possible accompanying layer shifting of the fiber mats 5 among one another in this case, continuous sealing through all fiber mats 5 is ensured, which is shown in FIG. 4b after shaping of the fiber semifinished product 4 from FIG. 4a for the edge region 3a of a fiber preform 3. Protruding fibers of the fiber mats 5 may be easily cut off in the scope of trimming (net shaping).

FIGS. 5 and 6 show various applications of the application or the introduction of sealant material 6 to a fiber preform 3 before or after trimming of the edge region 3a of the fiber preform 3.

FIG. 5 shows the application or the introduction of sealant material 6 to at least two layers of the fiber mats 5 of a fiber preform 3 obtained by shaping a fiber semifinished product 4—in particular the uppermost and lowermost layers. As shown, the sealant material 6 is introduced over the uppermost and lowermost layers until the complete sealing of all fiber pores and fiber intermediate spaces of the fiber preform 3 located between the introduction points.

FIG. 6 shows the adhesion of sealant material 6 to an edge section 3a, which is preferably already trimmed, of a fiber preform 3. In this case. FIG. 6a shows a sealant material 6, implemented as a sealing cord, in the non-squeezed state and FIG. 6b shows its sealing action by squeezing using the tool upper part 21 of the molding tool 20.

FIGS. 7 and 8 show various applications of the application or the introduction of sealant material 6 to the cut edge 3b of an already trimmed fiber preform 3.

FIG. 7 shows the adhesion of sealant material 6 to the cut edge 3b of a vertically trimmed edge section 3a of a fiber preform 3. In the case of the illustrated preferred embodiment of a U-shaped application—preferably using an adapted flat nozzle having U-profile—the sealant material 6 can advantageously penetrate into the fiber preform 3 not only from above and below, but rather via the cut edge 3b for the complete sealing, which is advantageously accompanied by reduced introduction time in relation to sealant material 6 which is only introduced from above and from below.

FIG. 8 shows the adhesion of sealant material 6 to the cut edge 3b of an edge section 3a, which is trimmed in a wedge shape, for example, tapering upward, of a fiber preform 3. In addition to the reduced introduction time, this embodiment additionally has freedom from pores over the entire thickness of the preform 3 as an advantage and also displays better sealing properties.

Finally, both embodiments shown in FIGS. 7 and 8 share the advantage of a fixation of the cut edge 3b over all layers of the fiber preform 3, to which easier handling of the fiber preform 3, in particular during the transport and laying in the molding tool 20, is linked as an additional advantage.

Of course, the embodiments shown in FIGS. 3 to 8 can also be applied entirely or partially in combination to fiber mats 5, fiber semifinished products 4, and/or fiber preforms 3 (not shown).

Finally, FIG. 9 shows examples of typical process steps a) to d) in an RTM facility for performing an HP-RTM method for producing a fiber-reinforced plastic component 1.

FIG. 9a shows the molding tool 20, which comprises at least two tool parts 21, 22, of an RTM facility in an open position. In this case, the upper tool part (patrix) 21 and the lower tool part (matrix) 22 are implemented as corresponding to one another such that, in a final closed position, they implement a cavity corresponding to the main form 2 of the plastic component 1, into which a resin system is later injected. To keep the molding tool 20 tightly closed in relation to the ambient air pressure during the injection of the resin via an injection facility 24, for the infiltration of the fiber preform 3, at least one main seal 23, which contains elastomeric material in particular, is located between tool upper part 21 and tool lower part 22. Depending on the construction of the tool parts 21 and 22, however, two or more so-called seals 23a and 23b can also be provided—as shown in FIG. 9a—which seal a tool part 21 with the other tool part 22 completely in relation to the ambient air pressure thereof, for example, circumferentially. For the evacuation of the cavity required before the infiltration, at least one opening 25 to a vacuum connection is implemented in at least one tool part 21, 22—shown in the tool lower part 22 in FIG. 9a.

FIG. 9b shows the two-part molding tool 20 of an RTM facility from FIG. 9a having a premolded fiber preform 3—but shown as essentially flat in the exemplary embodiment for simplification—laid therein, having sealant material 6 integrated in the edge region 3a thereof, in which, in a complete circumferential edge region 3a of the fiber preform 3, all fiber pores and fiber intermediate spaces therein are thus closed by the sealant material 6. It is recognizable how, in a first closed position, the first partially closed tool parts 21 and 22 are already closable airtight in relation to one another via the lower circumferential sealant 23a and the cavity thus formed can be evacuated via the opening 25 to a vacuum connection.

FIG. 9c shows the two-part tool 20 of an RTM facility from FIG. 9b in a second, further-closed closed position, in which the opening 25 to the vacuum connection is now additionally sealed by the first (lower) seal 23a in relation to the cavity formed by the tool parts 21, 22 and the tool parts 21, 22 are additionally sealed by a second (upper) seal 23b, so that vacuum can also be maintained in the molding tool 20 via the opening 25 when the tool parts 21, 22 have already been moved into the second closed position for an introduction of the resin system into the evacuated cavity. The risk of undesired air enclosures in the plastic component 1 is therefore always avoided, advantageously even in particular if an HP-CRTM process is carried out in the RTM facility, i.e., in the second closed position, the tool parts 21 and 22 are first closed to a defined gap dimension, to inject resin without noticeable flow resistances above or—as shown—below the outer layer of the fiber preform 3 and to over-compact it in a final closed position with subsequent closing of the tool parts 21, 22.

FIG. 9d shows the two-part molding tool 20 of an RTM facility from FIG. 9c in a third, final closed position, in which the cavity left by the tool parts 21 and 22 now corresponds to the desired component thickness of the plastic component 1 to be manufactured, so that the previously injected resin is pressed into the pores and intermediate spaces of the fiber preform 3, without passing the integrated seal previously implemented in the fiber preform 3 by means of the sealant material 6 in this case.

Finally, a final form of the plastic component 1 (cf. FIG. 1h) can be obtained by simply trimming the main form 2 (cf. FIG. 1g) of the plastic component 1 while cutting off the sealant material 6.

Depending on the desired specification of the plastic component, it can contain mats made of glass fibers, carbon fibers, ceramic fibers, aramid fibers, boron fibers, steel fibers, natural fibers, nylon fibers, or comparable fibers and/or mixtures thereof and/or also so-called random fiber mats (recycled fiber mats).

The implementation according to the invention of a fiber preform 3 having integrated seal, i.e., having a completely circumferential edge region 3a which is closed by the sealant material 6, has the advantage that even at high injection pressures of, for example, 35 bar and/or high tool pressures of, for example, 100 or more bar, as these pressures are intrinsic to HP-RTM processes in particular, no resin can pass the fiber pores and fiber intermediate spaces, which are closed using sealant material 6, of the completely circumferential edge region of the fiber preform 3.

It can therefore also advantageously be ensured for the first time for HP-RTM methods that no resin reaches the main seals 23 or seals 23a, 23b arranged in the RTM tool between the tool parts 21, 22 of a molding tool 20, so that these seals also are no longer soiled by resin and have to be cleaned or cyclically replaced in a time-consuming manner.

### LIST OF REFERENCE SIGNS: P1441

1 plastic component
2 main form of 1
3 fiber preform
3a edge region of 3
3b cut edge of 3
4 fiber semifinished product
4a edge region of 4
5 fiber mats
6 sealant material
10 facility
11 application and/or introduction means
12 flathead nozzle
20 molding tool
21 tool part of 20
22 tool part of 20
23 main seal
23a seal
23b seal
24 injection facility
25 opening
30 preform tool
31 tool part
32 tool part
33 means
34 squeezing edge

1. A method for producing a fiber-reinforced plastic component, at least comprising the following method steps:
1.1 cutting individual fiber mats to size;
1.2 stacking multiple fiber mats to form a fiber semifinished product outside or inside a molding tool, which comprises at least two tool parts;
1.3 performing a preform process to produce a fiber preform of the plastic component; and
1.4 performing an RTM process to produce a main form of the plastic component;
characterized by application and/or introduction, which is before, simultaneous, and/or after in relation to method steps 1.2 and/or 1.3, of an at least partially circumferential sealant material, which is suitable for use as a sealant, to individual, multiple, and/or all fiber mats and/or the fiber semifinished product such that at latest before the performance of the RTM process provided according to method step 1.4, in a particularly completely circumferential edge region of the fiber preform, all fiber pores and intermediate spaces therein are closed by the sealant material.

2. The method according to claim 1, wherein the sealant material is at least partially circumferentially applied and/or introduced on individual, multiple, and/or all fiber mats during or after the cutting to size of the fiber mats provided according to method step 1.1.

3. The method according to claim 1, wherein the sealant material is at least partially circumferentially applied and/or introduced on individual, multiple, and/or all fiber mats before or during the stacking of fiber mats to form a fiber semifinished product provided according to method step 1.2.

4. The method according to claim 1, wherein the sealant material is at least partially circumferentially applied and/or introduced on the fiber semifinished product before the performance of a preform process provided according to method step 1.3.

5. The method according to claim 1, wherein the sealant material is at least partially circumferentially applied and/or introduced on the fiber preform after the performance of a preform process provided according to method step 1.3.

6. The method according to claim 1, wherein trimming of the edge region of the fiber mats, the fiber semifinished product and/or the fiber preform is performed before or after the application and/or the introduction of the sealant material.

7. The method according to claim 1, wherein the sealant material is a sealing cord and/or an adhesive and/or an elastomeric material, for example, silicone or polyurethane, and/or such a material having low viscosity properties in the uncured state for penetration into the fiber pores and intermediate spaces of the fiber mat, the fiber semifinished product, and/or the fiber preform.

8. The method according to claim 1, wherein a fixation of the fiber mats, which were stacked according to method step 1.2 to form a fiber semifinished product, among one another is performed by means of binding agents and/or by means of the sealant material.

9. The method according to claim 1, wherein the sealant material is a material such that it has preferably rapid curing properties after application, either natural or artificially promoted.

10. The method according to claim 1, wherein a final form of the plastic component is obtainable by trimming the main form of the plastic component while cutting off the sealant material.

11. A facility for carrying out a method for producing a fiber-reinforced plastic component, according to claim 1, at least comprising the following method steps:
1.1 cutting individual fiber mats to size;
1.2 stacking multiple fiber mats to form a fiber semifinished product outside or inside a molding tool, which comprises at least two tool parts;
1.3 performing a preform process to produce a fiber preform of the plastic component; and
1.4 performing an RTM process to produce a main form of the plastic component;
wherein the facility includes an application and/or introduction device for the purpose of application and/or introduction, which is before, simultaneous, and/or after in relation to method steps 1.2 and/or 1.3, of an at least partially circumferential sealant material, which is suitable for use as a sealant, to individual, multiple, and/or all fiber mats and/or the fiber semifinished product such that at latest before the performance of the RTM process provided according to method step 1.4, in a particularly completely circumferential edge region of the fiber preform, all fiber pores and intermediate spaces therein are closed by the sealant material.

12. The facility according to claim 11, which is implemented as a flathead nozzle, and which is guided at a defined spacing to a fiber mat or a fiber semifinished product so that the material which is suitable for use as a sealant is applied and/or introduced by means of the flathead nozzle, in that it pumps the sealant material, preferably with pressure, into the fiber pores and intermediate spaces of one or more fiber mats.

13. The facility according to claim 11 wherein a squeezing edge is implemented, in at least one preform tool part of the preform tool for producing the fiber preform and/or in at least one tool part of the molding tool for producing the main form at the height coming to rest in the tool parts of the sealant material applied and/or introduced on the fiber mats and/or the fiber semifinished product, by means of which the sealant material can be introduced during the closing of the molding tools into all fiber pores and intermediate spaces therein of each fiber mat and/or can be over-compacted after already completed introduction.

14. The facility according to claim 11, wherein devices for promoting curing of the sealant material by means of heat action, for example, hot presses, are provided in the preform tool for producing the fiber preform.

15. The facility according to claim 11, characterized by molding tools, using which method steps 1.3 and 1.4 can be performed in the same or in different, successively mounted tool parts.
